(19) United States
(12) Patent Application Publication
(10) Pub. No.: US 2006/0055334 A1
(43) Pub. Date: Mar. 16, 2006

(54) Electric incandescent lamp

(75) Inventor: Roland Rittner, Herbrechtingen (DE)

Correspondence Address: OSRAM SYLVANIA INC, 100 ENDICOTT STREET, DANVERS, MA, 01923, US

(73) Assignee: PATENT-TREUHAND-GESELLSCHAFT FUR ELEKTRISCHE GLUHLAMPEN MBH, MUNCHEN (DE)

(21) Appl. No.: 11/213,804

(22) Filed: Aug. 30, 2005

(30) Foreign Application Priority Data
Sep. 10, 2004 (DE) 102004044365.3

(51) Int. Cl. H01J 13/46

(52) U.S. Cl. 315/46

(57) ABSTRACT

The invention relates to an electric incandescent lamp having power supply wires for at least one incandescent filament, at least one power supply wire being provided with a hole in which an outgoing filament line of the at least one incandescent filament is fixed.

### I. TECHNICAL FIELD

The invention relates to an electric incandescent lamp having power supply wires for at least one incandescent filament.

### II. BACKGROUND ART

Such an incandescent lamp is described, for example, in the German laid-open specification DE 44 28 357 A1. This specification has disclosed a halogen incandescent lamp having incandescent filaments whose outgoing filament lines are each surrounded by a molybdenum tube in order to weld them to a power supply wire or to an anti-dazzle device.

### III. SUMMARY OF THE INVENTION

The object of the invention is to provide a generic incandescent lamp having a simplified means for holding the incandescent filament.

This object is achieved according to the invention by an electric incandescent lamp having power supply wires for at least one incandescent filament, wherein at least one power supply wire is provided with a hole in which an outgoing filament line of the at least one incandescent filament is fixed. Particularly advantageous embodiments of the invention are described in the dependent patent claims.

The electric incandescent lamp according to the invention has power supply wires for at least one incandescent filament, at least one power supply wire being provided, according to the invention, with a hole in which an outgoing filament line of the at least one incandescent filament is fixed. As a result, the outgoing filament line of the at least one incandescent filament can be welded to the power supply wire directly without using the molybdenum tube in accordance with the prior art.

### IV. BRIEF DESCRIPTION OF THE DRAWINGS

The invention will be explained in more detail below with reference to a preferred exemplary embodiment. In the drawing:

FIG. 1 shows a first power supply wire having a hole which is introduced transversely with respect to the longitudinal direction of said first power supply wire,

FIG. 2 shows a second power supply wire having a hole which is introduced in the longitudinal direction, and

FIG. 3 shows an incandescent lamp having the power supply wires depicted in FIGS. 1 and 2 for the purpose of holding the filament.

### V. BEST MODE FOR CARRYING OUT THE INVENTION

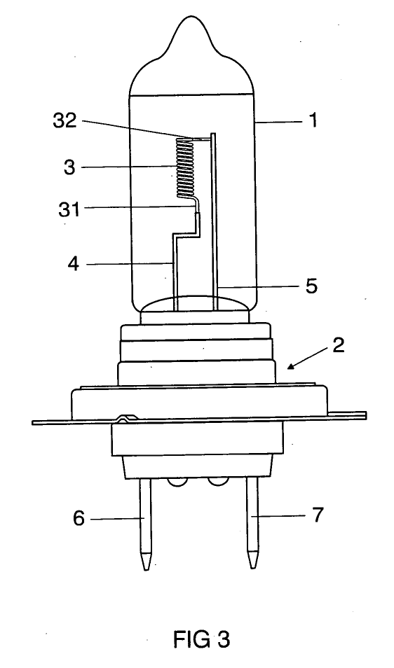

The preferred exemplary embodiment of the invention depicted in FIG. 3 is a halogen incandescent lamp for a vehicle headlight, in particular an H7 lamp. This lamp has a vitreous lamp vessel 1 which is provided at one end with a metallic lamp base 2. Arranged in the interior of the lamp vessel 1 is an axially aligned incandescent filament 3 made from tungsten, whose outgoing filament lines 31, 32 are each welded to a power supply wire 4 and 5, respectively, made from molybdenum. The power supply wires 4, 5 have a thickness or a diameter of 0.7 millimeter and are passed out of that end of the lamp vessel 1 which is sealed and is provided with the lamp base 2 and are each connected to an electrical connection 6 and 7, respectively, of the lamp base 2.

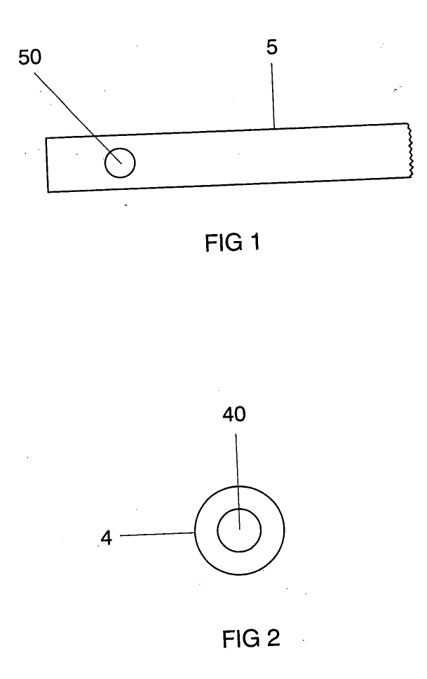

In order to fix the incandescent filament 2 to the first power supply wire 4, said first power supply wire 4 has, at one end, a hole 40 (FIG. 2), which extends in the longitudinal direction of said power supply wire 4, has a diameter of 0.5 millimeter and in which the first outgoing filament line 31 of the incandescent filament 2 is arranged and is fixed by means of a laser weld. The second outgoing filament line 32 of the incandescent filament 2 is arranged in the hole 50 of the second power supply wire 5 and is fixed by means of a laser weld. The hole 50 (FIG. 1) likewise has a diameter of 0.5 millimeter and extends transversely with respect to the longitudinal direction of the power supply wire 5. The two holes 40, 50 were produced by means of a laser.

The invention is not restricted to the exemplary embodiment which has been explained in more detail above. For example, the holes 40, 50 may also be produced by means of an electron beam or by spark erosion. In addition, the invention is not restricted to vehicle lamps but may also be used for other types of incandescent lamps.

What is claimed is:

1. An electric incandescent lamp having power supply wires for at least one incandescent filament, wherein at least one of said power supply wires is provided with a hole in which an outgoing filament line of said at least one incandescent filament is fixed.
